(19) United States
(12) Patent Application Publication
(10) Pub. No.: US 2003/0107827 A1
(43) Pub. Date: Jun. 12, 2003

(54) External rear-view mirror for a motor vehicle with a lamp arrangement

(76) Inventors: Manfred Marondel, Raebke (DE); Torsten Mueller, Muenchen (DE)

Correspondence Address: KENYON & KENYON, ONE BROADWAY, NEW YORK, NY, 10004, US

(21) Appl. No.: 10/149,710

(22) PCT Filed: Dec. 1, 2000
(86) PCT No.: PCT/EP00/12128

(30) Foreign Application Priority Data
Dec. 10, 1999 (DE) 19959609.3

(51) Int. Cl. G02B 5/08; G02B 7/18

(52) U.S. Cl. 359/842

(57) ABSTRACT

An external rear-view mirror for a motor vehicle is described, comprising a mirror housing (1) and a mirror base (4). The mirror housing comprises a mirror (6), on its rear side (2) and at least one lamp device (7), with at least one light source, that has a light outlet opening with a cover screen (3), for the light source arranged in the mirror housing (1). According to the invention the at least one light source comprises several distributed light diodes (12, 13).

The present invention relates to an outside rear view mirror for a vehicle, having a mirror housing and a mirror base; the mirror housing including a mirror on the back side of the mirror housing, and at least one lamp device, and the lamp device having at least one light source, which is assigned at least one light opening having a lens, in the mirror housing.

Described in DE 298 19 279 is an outside rearview mirror for vehicles that includes a mirror base and a mirror head, which has a mirror-glass support and in which at least one turn-signal lamp is accommodated, the turn-signal lamp being situated behind a light window. In the outside rearview mirror, the turn-signal lamp is positioned in the mirror head in such a manner, that it rearwardly radiates light in the travel direction of the vehicle, at an angle of at least 55° to a straight line, which is parallel to the vehicle axis and runs essentially outside the periphery of the mirror head.

In addition, the European patent application EP 858 932 A2 describes an outside rearview mirror for vehicles, where a glass backing plate is accommodated in a mirror housing, so as to be adjustable. The mirror housing also has a light source, which is assigned a light opening in the mirror housing. The oblong light opening is filled in by a fiber optic guide, which is connected to the light source inside the mirror housing. The light emitted by the light source should simply be directed through the fiber optic guide to the light opening.

The object of the present invention is to provide an outside rearview mirror having a lamp device, in particular a turn-signal lamp device, where transmission angles relevant for design certification are considered.

This object is achieved by the features of claim 1. Preferred embodiments of the present invention are the subject matter of the dependent claims.

The present invention provides for the least one light source being made of a plurality of distributed light-emitting diodes, the light-emitting diodes emitting their light in the direction of the lens, either directly or via reflectors. According to a preferred variant, the lamp device includes at least one first light-emitting diode, which is positioned in the lamp device in such manner, that the light radiated by the light-emitting diode is emitted laterally and/or laterally in the rearward direction, in relation to the vehicle. The preferred variant also provides for the lamp device including a plurality of the second light-omitting diodes, which are positioned in the lamp device-in such manner, that the light radiated by them is essentially radiated forwards with respect to the forward traveling direction of the vehicle.

In this context, the light-emitting diodes are preferably arranged in the lamp device in a ribbon-like manner and therefore form an elongated lamp device, which preferably extends across most of the width of the mirror housing.

In a specific embodiment, the light-emitting diodes are positioned in several side-by-side rows.

A further development of the present invention provides for the lamp device being situated essentially in the lower region of the mirror housing, in relation to the vehicle, it also being conceivable to position the lamp device in the center of the mirror housing.

According to a design of the present invention, the at least one, first light-emitting diode is positioned in the lamp device in such manner, that, in relation to the forward driving direction of the vehicle, the light-emitting diode radiates laterally, in the rearward direction, at an angle of at least 55° to a straight line, which is parallel to the vehicle axis and runs essentially outside the periphery of the mirror housing. The at least one light-emitting diode preferably radiates its light in an angular range of at least 60°.

In addition, at least a further, third light-emitting diode may be provided, which is situated on the back side of the mirror housing in relation to the forward travel direction, and directly radiates its light in a rearward direction. A refinement of this variant according to the present invention provides for a plurality of third light-emitting diodes, which are positioned on the edge of the mirror housing, around the mirror, it also being conceivable to design the mirror to be semitransparent and to position at least a portion of the third light-emitting diodes behind the mirror.

The present invention is elucidated in the following, using an exemplary embodiment. The corresponding drawings show:

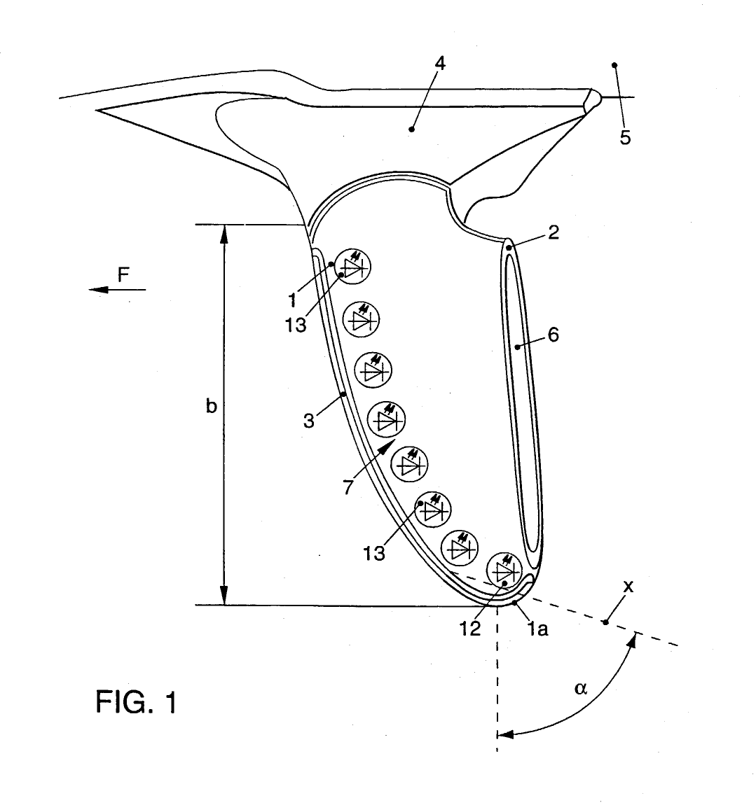

FIG. 1 a plan view and partial section of the outside mirror according to the present invention; and

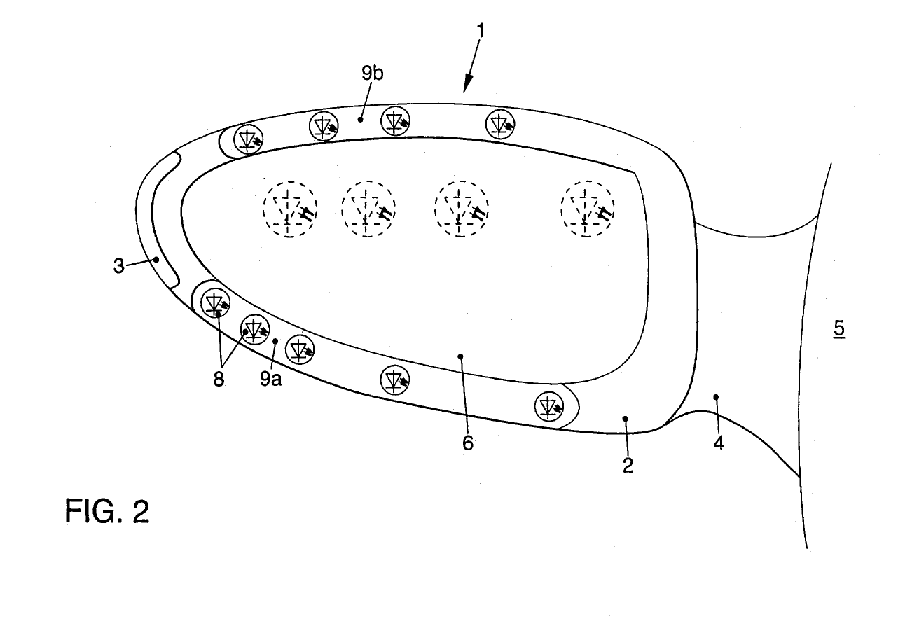

FIG. 2 a rear view of the outside mirror according to the present invention.

The outside mirror of the present invention represented in FIG. 1 essentially includes a mirror base 4, which is attachable or attached to a vehicle 5 and is, in turn, joined to mirror housing 1 by a joint not shown. Back side 2 of mirror housing 1 has a mirror 6 that is, in turn, articulated in mirror housing 1. In addition, a lamp device 7 having an elongated, ribbon-like, transparent lens 3 is provided in mirror housing 1, lamp device 7 extending at least partially over the free end of mirror housing 1, towards back side 2, and taking up a substantial part of the width b of mirror housing 1. Distributed across the front of mirror housing 1 in lamp device 7 is a plurality of second light-emitting diodes 13, which forwardly radiate their light directly and/or via reflectors, in the direction of lens 3, with respect to forward travel direction F of the vehicle. In addition, lamp device 7 has at least one further, first light-emitting diode 12 on the free end of mirror housing 1, this first light-emitting diode 12 laterally radiating its light in the rearward direction with respect to travel direction F of vehicle 5, at an angle α of at least 55° to a straight line x parallel to the vehicle axis.

FIG. 2 shows a rear view of the outside rearview mirror according to the present invention. In this exemplary embodiment, at least one further lamp device having third light-emitting diodes 8 is provided on the back side 2 of the mirror housing; the lamp device being provided with a uniform lens or partial lenses 9a, 9b, at least partially around the edge of mirror 6. Another possibility is for mirror 6 to be partly transparent or semitransparent, and for at least a part of the light-emitting diodes to be situated behind mirror 6. As can be seen from FIG. 2, the number of light-emitting diodes 8 per unit surface area in the exemplary embodiment reaches its maximum at free end 1a of mirror housing 1.

The lamp device 7 having light-emitting diodes 12 and 13 is particularly and advantageously suitable as a turn-signal lamp.

List of Reference Numerals

| | |
|---|---|
| 1 | mirror housing |
| 1a | free end of the mirror housing |
| 2 | back side of the mirror housing |
| 3 | lens |
| 4 | mirror base |
| 5 | vehicle |
| 6 | mirror |
| 7 | lamp device |
| 8 | light-emitting diodes |
| 9a, 9b | lens |
| 12 | light-emitting diodes |
| 13 | light-emitting diodes |
| x | axis |
| α | angle |
| F | forward travel direction |
| b | width |

1. An outside rearview mirror for a vehicle, comprising a mirror housing (1) and a mirror base (4), the mirror housing (1) including a mirror (6) on its back side (2) and at least one lamp device (7), which has a least one light source; the at least one light source being assigned at least one light opening having a lens (3), in the mirror housing, and being made of a plurality of distributed light-emitting diodes (12, 13),
wherein the lamp device (7) is situated essentially in the lower region of the mirror housing (1), with respect to the vehicle (5).

2. An outside rearview mirror for a vehicle, having a mirror housing (1) and a mirror base (4), the mirror housing (1) including a mirror (6) on its back side (2) and at least one lamp device (7), which has at least one light source;
the at least one light source being assigned at least one light opening having a lens (3), in the mirror housing (1), and being made of a plurality of distributed light-emitting diodes (12, 13),
wherein at least one further light-emitting diode (8) is provided, which is situated on the back side (2) of the mirror housing (1) with respect to the forward travel direction (F) of the vehicle, and directly radiates light in a rearward direction with respect to the travel direction (F).

3. The outside rearview mirror as recited in claim 2,
wherein the lamp device (7) is situated essentially in the lower region of the mirror housing (1), with respect to the vehicle (5).

4. The outside rearview mirror as recited in one of the preceding claims,
wherein the lamp, device (7) includes a least one first light-emitting diode (12), which is positioned in the lamp device (7) in such a manner, that the light radiated by the light-emitting diode is emitted laterally with respect to the longitudinal extension of the vehicle (5); and the lamp device includes a plurality of second light-emitting diodes (13), which are positioned in the lamp device (7) in such manner, that the light radiated by them is essentially emitted in the forward direction with respect to the forward travel direction (F) of the vehicle (5).

5. The outside rearview mirror as recited in one of the preceding claims,
wherein the light-emitting diodes (12, 13) are arranged in a ribbon-like manner.

6. The outside rearview mirror as recited in claim 5,
wherein the light-emitting diodes (12, 13) essentially form a plurality of vertical rows.

7. The outside rearview mirror as recited in one of the preceding claims,
wherein the lamp device (7) is positioned over a substantial part of the width (b) of the mirror housing (1).

8. The outside rearview mirror as recited in claim 2,
wherein the lamp device (7) is positioned essentially vertically with respect to the vehicle, in the center of the mirror housing (1).

9. The outside rearview mirror as recited in one of claims 4 through 8,
wherein the at least one first light-emitting diode (12) is positioned in such a manner that, in relation to the forward travel direction (F) of the vehicle (5), the first light-emitting diode (12) radiates laterally in the rearward direction, at an angle (α) of at least 55° to a straight line (x), which is parallel to the longitudinal vehicle axis and runs essentially outside the periphery of the mirror housing (1).

10. The outside rearview mirror as recited in claim 9, wherein the at least one first light-emitting diode (12) emits light in an angular range (a) of at least 60°.

11. The outside rearview mirror as recited in one of claims 2 through 10,
wherein a plurality of light-emitting diodes (8) is provided, which are positioned on the edge of the mirror housing (1), around the mirror.

12. The outside rearview mirror as recited in one of claims 2 through 11,
wherein the mirror (6) is semitransparent, and at least a portion of the light-emitting diodes (8) is situated behind the mirror (6).

13. The outside rearview mirror as recited in one of claims 2 through 12,
wherein the number of light-emitting diodes (8) per unit surface area is at a maximum on the free end (1a) of the mirror housing (1).
